(19) United States
(12) Patent Application Publication
(10) Pub. No.: US 2023/0283523 A1
(43) Pub. Date: Sep. 7, 2023

(54) HANDLING, CONTROLLING, AND MANAGING INTERNET PROTOCOL ASSETS USING MACHINE LEARNING

(71) Applicant: AT&T Intellectual Property I, L.P., Atlanta, GA (US)

(72) Inventors: Nishan Singh, Freehold, NJ (US); Subrat Patra, Schaumburg, IL (US); Abdulla Udaipurwala, Monroe Township, NJ (US)

(21) Appl. No.: 17/653,007

(22) Filed: Mar. 1, 2022

(51) Int. Cl. H04L 41/12; H04L 69/16; H04L 41/14; H04L 47/78

(52) U.S. Cl. CPC H04L 41/12; H04L 69/161; H04L 41/14; H04L 47/78

(57) ABSTRACT

Devices, computer-readable media, and methods for reclaiming and reallocating stranded Internet Protocol assets are disclosed. In one example, a method includes acquiring a plurality of reports detailing the usage and availability of a packet-switched network, classifying, based on the plurality of reports, a plurality of hosts in the packet-switched network, identifying, based on the classifying, a first host of the plurality of hosts from which to reclaim an Internet Protocol asset, and reclaiming the Internet Protocol asset from the first host and reassigning the Internet Protocol asset to a pool of available Internet Protocol assets.

The present disclosure relates generally to telecommunication networks and relates more particularly to devices, non-transitory computer-readable media, and methods for handling, controlling, and managing Internet Protocol assets using machine learning.

### BACKGROUND

Internet Protocol (IP) is a network layer communications protocol for relaying data packets across a packet-switched network. To this end, IP defines the format of the data packets and provides an addressing system for use in routing the data packets. IP addressing includes assigning IP addresses to host interfaces. Multiple versions of IP have been put into use, with the most recently used versions including IP version 4 (IPv4) and IP version 6 (IPv6). IPv4 uses a 32-bit address space, which provides 4,294,967,296 (232) unique addresses; however, large address blocks are reserved for private networks (approximately eighteen million addresses) and multicast addresses (approximately two hundred seventy million addresses). Although IPv6 has been introduced to provide a larger address space, a full transition from Ipv4 to IPv6 is expected to take many years.

### SUMMARY

In one example, the present disclosure describes devices, computer-readable media, and methods for reclaiming and reallocating stranded Internet Protocol assets using machine learning. For instance, in one example, a method includes acquiring a plurality of reports detailing the usage and availability of a packet-switched network, classifying, based on the plurality of reports, a plurality of hosts in the packet-switched network, identifying, based on the classifying, a first host of the plurality of hosts from which to reclaim an Internet Protocol asset, and reclaiming the Internet Protocol asset from the first host and reassigning the Internet Protocol asset to a pool of available Internet Protocol assets.

In another example, a non-transitory computer-readable medium stores instructions which, when executed by a processing system including at least one processor, cause the processing system to perform operations. The operations include acquiring a plurality of reports detailing the usage and availability of a packet-switched network, classifying, based on the plurality of reports, a plurality of hosts in the packet-switched network, identifying, based on the classifying, a first host of the plurality of hosts from which to reclaim an Internet Protocol asset, and reclaiming the Internet Protocol asset from the first host and reassigning the Internet Protocol asset to a pool of available Internet Protocol assets.

In another example, a system includes a processing system including at least one processor and a computer-readable medium storing instructions which, when executed by the processing system, cause the processing system to perform operations. The operations include acquiring a plurality of reports detailing the usage and availability of a packet-switched network, classifying, based on the plurality of reports, a plurality of hosts in the packet-switched network, identifying, based on the classifying, a first host of the plurality of hosts from which to reclaim an Internet Protocol asset, and reclaiming the Internet Protocol asset from the first host and reassigning the Internet Protocol asset to a pool of available Internet Protocol assets.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates one example of the provisioning server of FIG. 1 in more detail;

FIG. 3 illustrates a flowchart of an example method for reclaiming stranded Internet Protocol assets using machine learning, in accordance with the present disclosure;

FIG. 4 illustrates a flowchart of an example method for allocating Internet Protocol assets using machine learning, in accordance with the present disclosure;

FIG. 5 illustrates a flowchart of an example method for using machine learning to notify an administrator when the provisioning of new Internet Protocol assets is needed, in accordance with the present disclosure; and

FIG. 6 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe devices, non-transitory computer-readable media, and methods for handling, managing, and controlling Internet Protocol assets using machine learning. As discussed above, IPv4 uses a 32-bit address space, which provides 4,294,967,296 (232) unique addresses. The growing number of Internet users and the increasing use of devices that rely on IP data services, such as smart phones, laptop computers, tablet computers, wearable devices (e.g., smart watches and head mounted displays), Internet of Things (IoT) devices, and the like, have depleted the pool of available IPv4 addresses. Although IPv6 has been introduced to provide a larger address space, a full transition from Ipv4 to IPv6 is expected to take many years. As such, efficient management and allocation of existing IPv4 assets remains critical in the interim.

Examples of the present disclosure provide automated, machine learning-driven solutions for handling, managing, and controlling IP assets, including solutions for reclaiming and reallocating stranded IP assets (e.g., IP assets that have been allocated, but are unused or no longer needed by the hosts to which they have been allocated). In one particular example, stranded IP assets may be identified based on analysis of various reports describing network usage and availability. Within the context of the present disclosure, a “stranded” IP asset may refer to an IP asset that is allocated but unused or underutilized (e.g., a block of IP addresses that is assigned to a router that is not meant to be utilized in the network long term or that is used infrequently). Stranded IP assets that are identified may be reclaimed and reassigned to a pool of available IP assets (which may include IP assets that have never been allocated as well as reclaimed IP assets). IP assets may then be allocated from this pool of available IP assets to hosts in the network based on need (e.g., frequency of use, likelihood of long term use, etc.).

In a further example, the reports describing network usage and availability may also be analyzed to help guide allocation of the IP assets from the pool of available IP assets to hosts in the network based on need. For instance, hosts may be classified according to observed and/or expected usage based on the reports. Hosts with higher usage rates may be allocated larger blocks of IP addresses, while hosts with lower usage rates may be allocated smaller blocks of IP addresses. In a further example still, analysis of the reports describing network usage and availability may be used to predict when the pool of available IP assets may be depleted, triggering an alert that notifies a human management team of the need to provision additional IP assets.

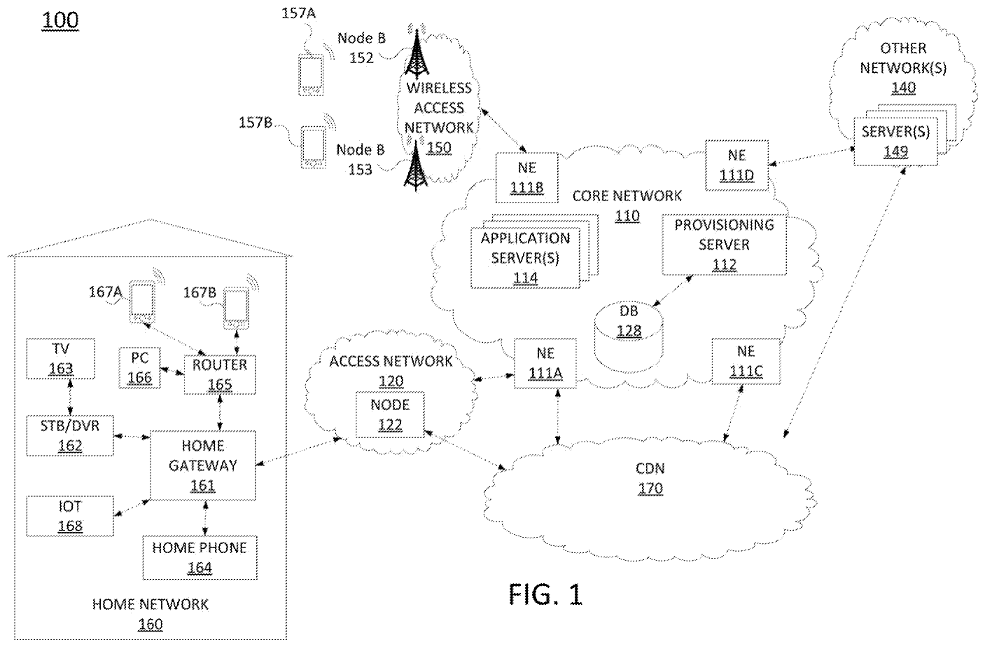

Within the context of the present disclosure, an “IP asset” is understood to refer to an Internet Protocol address or a block of Internet Protocol addresses. The IP assets may include IPv4 assets, IPv6 assets, and/or assets in accordance with any other version of the Internet Protocol. A “stranded” IP asset is an IP asset that has previously been allocated to a host, but is no longer needed or in use by the host. For instance, a large block of IP addresses may be allocated to an organization, such as a university, a government agency, or the like. However, the organization may not utilize the full block of IP addresses. According to examples of the present disclosure, IP assets that have been stranded in this manner may be identified, reclaimed, and re-allocated automatically. These and other aspects of the present disclosure are described in greater detail below in connection with the examples of FIGS. 1-6.

To better understand the present disclosure, FIG. 1 illustrates an example network 100, related to the present disclosure. As shown in FIG. 1, the network 100 connects mobile devices 157A, 1578, 167A and 1678, and home network devices such as home gateway 161, set-top box (STB) 162, television (TV) 163, home phone 164, router 165, personal computer (PC) 166, Internet of Things (IoT) device 168, and so forth, with one another and with various other devices via a core network 110, a wireless access network 150 (e.g., a cellular network), an access network 120, other networks 140, content distribution network (CDN) 170, and/or the Internet in general. For instance, connections between core network 110, access network 120, home network 160, CDN 170, and other networks 140 may comprise the Internet in general, internal links under the control of single telecommunication service provider network, links between peer networks, and so forth.

In one embodiment, wireless access network 150 comprises a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), “fifth generation” (5G), Long Term Evolution (LTE) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by a same entity as core network 110

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, wireless access network 150, access network 120, and so forth. As shown in FIG. 1, core network 110 may also include a provisioning server 112 and a plurality of application servers 114. For ease of illustration, various additional elements of core network 110 are omitted from FIG. 1.

In one example, the access network 120 may comprise a Digital Subscriber Line (DSL) network, a broadband cable access network, a Local Area Network (LAN), a cellular or wireless access network, a 3rd party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between home network 160 and core network 110 relating to voice telephone calls, communications with web servers via other networks 140, content distribution network (CDN) 170 and/or the Internet in general, and so forth. In another example, access network 120 may be operated by a different entity from core network 110, e.g., an Internet service provider (ISP) network.

As illustrated in FIG. 1, core network 110 may include various application servers 114. For instance, application servers 114 may be implemented to provide certain functions or features, e.g., a Serving-Call Session Control Function (S-CSCF), a Proxy-Call Session Control Function (P-CSCF), or an Interrogating-Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. In one example, application servers 114 may include data storage servers to receive and store data structures or directories (e.g., manifest files) regarding content maintained within TV servers 112 and/or available to subscribers of core network 110 and stored in server(s) 149 in other networks 140. It should be noted that the foregoing are only several examples of the types of relevant application servers 114 that may be included in core network 110 for storing information relevant to providing various services to subscribers.

In accordance with the present disclosure, other networks 140 and servers 149 may comprise networks and devices of various content providers (e.g., providers of streaming video and audio content, image content, gaming content, and/or other types of content).

In one example, home network 160 may include a home gateway 161, which receives data/communications associated with different types of media, e.g., television, phone, and Internet, and separates these communications for the appropriate devices. The data/communications may be received via access network 120. In one example, television data is forwarded to set-top box (STB)/digital video recorder (DVR) 162 to be decoded, recorded, and/or forwarded to television (TV) 163 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, IoT device 168, and so forth. In one example, router 165 may further communicate with TV (broadly a display) 163, e.g., where the television is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

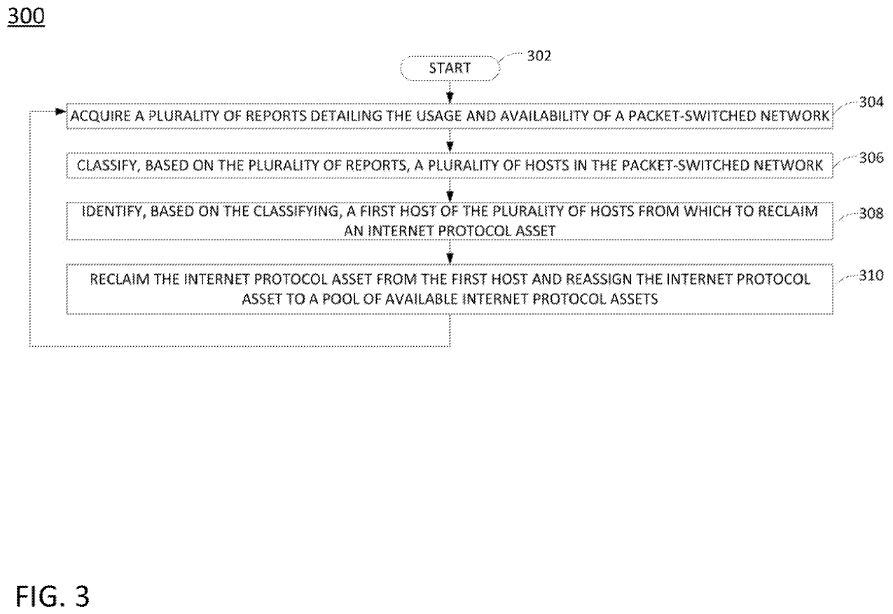

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. A flowchart of an example method for reclaiming and reallocating stranded Internet Protocol assets using machine learning is illustrated in FIG. 3 and described in greater detail below. Although STB/DVR 162 is illustrated and described as an integrated device with both STB and DVR functions, in other, further, and different examples, STB/DVR 162 may comprise separate STB and DVR devices.

Network 100 may also include a content distribution network (CDN) 170. In one example, CDN 170 may be operated by a different entity from core network 110. In another example, CDN 170 may be operated by a same entity as core network 110, e.g., a telecommunication service provider. In one example, the CDN 170 may comprise a collection of cache servers distributed across a large geographical area and organized in a tier structure. The first tier may comprise a group of servers that access content web servers (origin servers) to pull content into the CDN 170, referred to as an ingest servers. The content may include video programs, content of various webpages, electronic documents, video games, etc. A last tier may comprise content servers which deliver content to end users, typically from the edge of the CDN 170, referred to as content servers. There may be several layers of content servers, referred to as the middle tier. In one example, one or more of the content servers may be multi-tenant, serving multiple content providers, such as core network 110, content providers associated with server(s) 149 in other network(s) 140, and so forth.

The provisioning server 112 may be responsible for managing allocation of IP assets in the network 100. To this end, the provisioning server may perform a plurality of functions, including reclaiming stranded IP assets, allocating available IP assets (including reclaimed IP assets) to hosts requiring the IP assets, and requesting provisioning of new IP assets when it is anticipated that the available IP assets will be exhausted. The provisioning server 112 may perform these functions based on analysis of data stored in a database (DB) 128, which may store usage information (e.g., resources currently being used) and availability information (e.g., resources that are currently available to be allocated or assigned) about a plurality of network elements in the network 100 (e.g., NEs 111A-111D, application servers 114, servers 149, node 122, and devices in the home network 160, among others). In one example, the DB 128 may comprise a physical storage device integrated with the provisioning server 112 (e.g., a database server or a file server), or attached or coupled to the provisioning server 112, in accordance with the present disclosure. In one example, the provisioning server 112 may load instructions into a memory, or one or more distributed memory units, and execute the instructions for reclaiming and reallocating stranded Internet Protocol assets using machine learning as described herein.

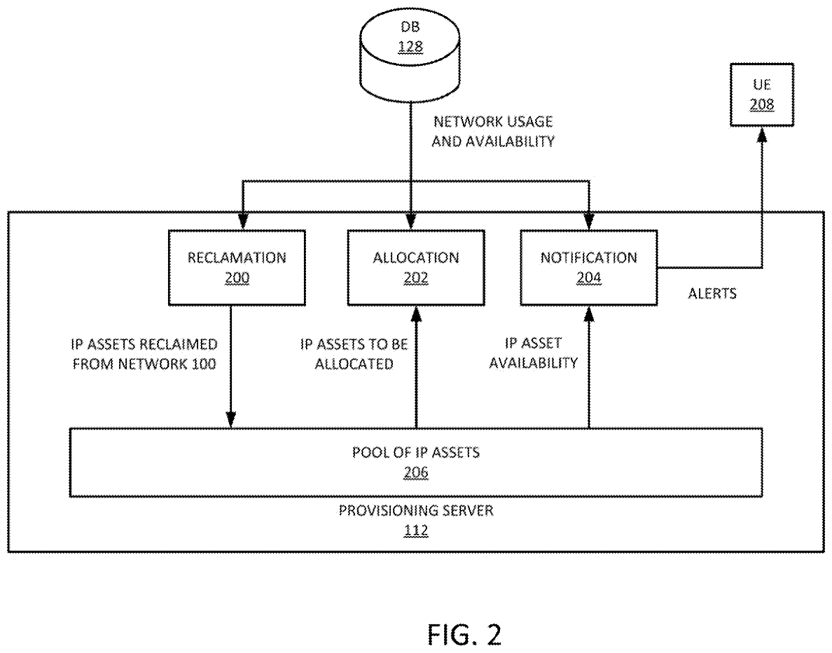

FIG. 2 illustrates one example of the provisioning server 112 of FIG. 1 in more detail. As illustrated, in one example, the provisioning server 112 may comprise reclamation logic 200, allocation logic 202, and notification logic 204. The reclamation logic 200, allocation logic 202, and notification logic 204 may each be communicatively coupled to the DB 128 and to a pool of IP assets 206.

In one example, the reclamation logic 200 is responsible for identifying and reclaiming stranded IP assets from the network 100. To this end, the reclamation logic 200 may utilize machine learning in order to analyze data from the DB 128 in order to identify when an IP asset has become stranded. Once the reclamation logic 200 has identified an IP asset as stranded, the reclamation logic 200 may reclaim the stranded IP asset. Reclamation of a stranded IP asset may involve de-provisioning the stranded IP asset (e.g., such that the stranded IP asset is no longer assigned to its current host) and returning the stranded IP asset to the pool of available IP assets 206 (where the stranded IP asset will become an available IP asset that may be provisioned by the allocation logic 202 as discussed in further detail below).

In one example, the allocation logic 202 is responsible for allocating available IP assets from the pool of available IP assets 206 among the hosts in the network 100. To this end, the allocation logic 202 may utilize machine learning in order to analyze data from the DB 128 in order to classify hosts in the network as “target hosts” (e.g., hosts which are expected to be busiest or exhibit high frequency of use in the network 100 in the future) or “non-target hosts” (e.g., hosts which are expected to be less busy or experience low frequency of use in the network 100 in the future). In other examples, other classifications of network hosts may be possible (e.g., numeric classifications, high/medium/low, or other classification systems). Whatever the classification system utilized, the allocation logic 202 may predict the expected needs of the hosts with respect to IP assets.

Once the allocation logic 202 has classified the hosts in the network, the allocation logic 202 may then determine an optimal allocation of the available IP assets among the hosts. In one example, allocation of the available IP assets may involve predicting the optimal block size of an IP asset (e.g., the optimal size of a block of IP addresses) to allocate to a host requiring the IP asset. In one example, the allocation logic 202 may allocate larger blocks of IP assets to target hosts (or hosts which are otherwise identified as having a need for greater IP assets), while allocating smaller blocks of IP assets to non-target hosts (or hosts which are otherwise identified as having a need for fewer IP assets). Allocation of an IP asset to a host may involve assigning the IP asset to the host.

In one example, the notification logic 204 is responsible for requesting the provisioning of new IP assets (e.g., from a human administrator or team). To this end, the notification logic 204 may utilize machine learning in order to analyze data from the DB 128, as well as the status of the pool of available IP assets 206, in order to predict the likelihood of the pool of available IP assets 206 being exhausted within some defined period of time. As long as the predicted likelihood falls below a predefined threshold, the notification logic 204 may take no further action. If, however, the predicted likelihood exceeds the predefined threshold, then the notification logic 204 may send an alert to a UE device 208 operated by a human administrator or team of administrators. The alert may request that new IP assets be provisioned for use by the hosts of the network 100.

Thus, the provisioning server 112 uses machine learning to analyze network usage and availability information (e.g., network resources currently being used and network resources that are currently available to be allocated or assigned) so that a limited pool of IP assets can be allocated in an optimal, automated manner. In one example, the provisioning server 112 may operate continuously in order to ensure that the information needed to optimize IP asset allocation is available when needed, minimizing delays that may impact network performance and lead to poor customer experience. Further details regarding the functions that may be implemented by provisioning server 112 are discussed in greater detail below in connection with the examples of FIGS. 3-5. In addition, those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

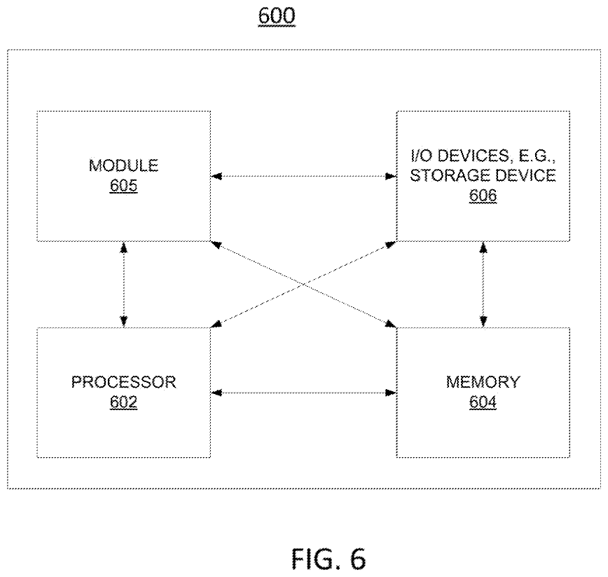

FIG. 3 illustrates a flowchart of an example method 300 for reclaiming stranded Internet Protocol assets using machine learning, in accordance with the present disclosure. In one example, the method 300 is performed by the provisioning server 112 of FIG. 1, by any one or more components thereof (e.g., reclamation logic 200, a processor performing operations stored in and loaded from a memory, etc.), or by the provisioning server 112 in conjunction with one or more other devices, such as application servers 114, servers 149, and so forth. In one example, the steps, functions, or operations of method 300 may be performed by a computing device or system 600, and/or processor 602 as described in connection with FIG. 6 below. For instance, the computing device or system 600 may represent any one or more components of a provisioning server or client device in FIG. 1 that is/are configured to perform the steps, functions and/or operations of the method 300. For illustrative purposes, the method 300 is described in greater detail below in connection with an example performed by a processing system.

The method 300 begins in step 302 and proceeds to step 304. In step 304, the processing system may acquire a plurality of reports detailing the usage and availability of a packet-switched network. In one example, the packet-switched network is an Internet Protocol (IP) network in which IP addresses (e.g., IPv4 and/or IPv6 addresses) are assigned to a plurality of hosts connected to the network.

In one example, the plurality of reports detailing the usage and availability of a packet-switched network may include one or more types of information such as: how many Layer 3 IP connections are present on a given host (e.g., router), the maximum number of permitted IP connections on the given host, the amount of bandwidth available on each network interface card (NIC) of the given host, the hardware platform types of the given host and NIC card(s), any network locks present on the given host and NIC card(s), and/or other information.

As discussed above, the plurality of reports may be acquired from one or more databases (e.g., DB 128) or from other sources in the packet-switched network. The plurality of reports may be pushed continuously to the processing system or may be provided to the processing system on-demand (e.g., in response to periodic queries issued by the processing system).

In step 306, the processing system may classify, based on the plurality of reports, a plurality of hosts in the packet-switched network. In one example, the hosts are classified based on how likely the hosts are to be utilized in the packet-switched network (or how busy or frequently used the hosts are likely to be) in the future. For instance, a given host may be classified as a “target host” if the given host is expected to be busy or utilized frequently in the packet-switched network in the future (and should, therefore, be allocated greater IP assets) or classified as a “non-target host” if the given host is not expected to be busy or utilized frequently in the packet-switched network in the future (and should, therefore, be allocated fewer IP assets). The plurality of hosts may be classified in a number of ways, such as target/non-target, high/medium/low frequency of predicted future use, on a numerical scale (e.g., one to ten, with one representing a low predicted frequency of use and 10 representing a higher predicted frequency of use), or other ways. In one example, a machine learning technique may take data from the plurality of reports as input and may generate as an output a predicted class for each host of the plurality of hosts. For instance, a clustering algorithm (e.g., a K means algorithm or other clustering algorithms) may be used to cluster the plurality of hosts into a plurality of clusters, where each cluster of the plurality of clusters is associated with a different class (e.g., different predicted usage frequency).

In step 308, the processing system may identify, based on the classifying, a first host of the plurality of hosts from which to reclaim an IP asset. In one example, the first host may be a host which is classified as a non-target host (or otherwise indicated to be unlikely to be frequently used in the packet-switched network in the future). For instance, the first host may be assigned to a cluster of hosts associated with a predicted usage frequency that is low relative to other clusters. In another example, the first host may be a host associated with a stranded IP asset. For instance, a large block of IP addresses may have been previously assigned to a non-target host, when a smaller block of IP addresses would have been sufficient. Thus, one or more portions of the large block of IP addresses may be underutilized or become stranded. In one example, a machine learning technique may take as input the classifications of the plurality of hosts and may generate as an output predictions (e.g., likelihoods) as to whether specific IP assets allocated to the hosts in particular classes may be stranded.

In step 310, the processing system may reclaim the IP asset from the first host and reassign the IP asset to a pool of available IP assets. In one example, the pool of available assets may include IP assets that have never been allocated, as well as reclaimed IP assets that were allocated at least once and subsequently reclaimed (e.g., due to being stranded or underutilized). IP assets in the pool of available IP assets may be available for allocation to hosts in the packet-switched network.

The method 300 may then return to step 304 and may continue as described above, continuously iterating through steps 304-310 until or if the method 300 is halted.

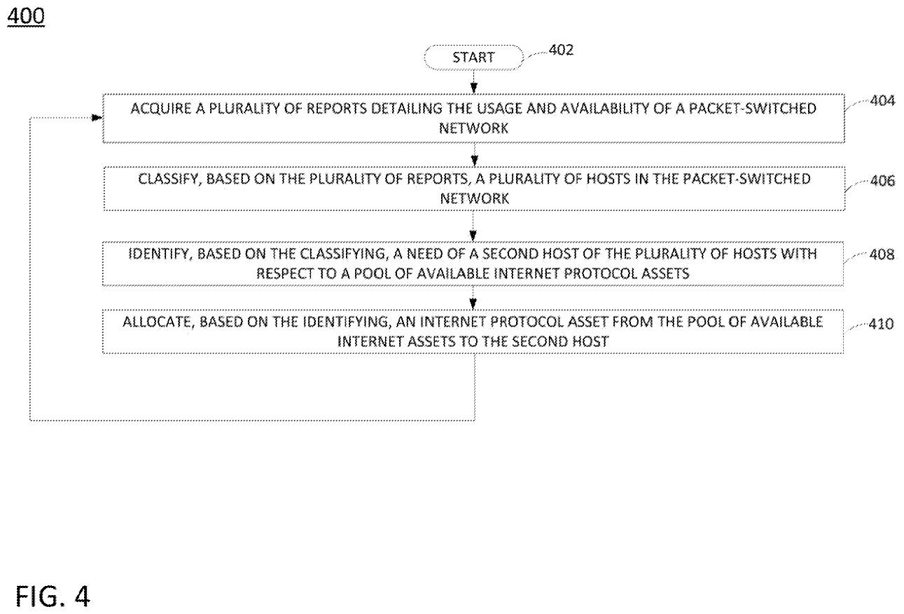

FIG. 4 illustrates a flowchart of an example method 400 for allocating Internet Protocol assets using machine learning, in accordance with the present disclosure. In one example, the method 400 is performed by the provisioning server 112 of FIG. 1, by any one or more components thereof (e.g., allocation logic 202, a processor performing operations stored in and loaded from a memory, etc.), or by the provisioning server 112 in conjunction with one or more other devices, such as application servers 114, servers 149, and so forth. In one example, the steps, functions, or operations of method 400 may be performed by a computing device or system 600, and/or processor 602 as described in connection with FIG. 6 below. For instance, the computing device or system 600 may represent any one or more components of a provisioning server or client device in FIG. 1 that is/are configured to perform the steps, functions and/or operations of the method 400. For illustrative purposes, the method 400 is described in greater detail below in connection with an example performed by a processing system.

The method 400 begins in step 402 and proceeds to step 404. In step 404, the processing system may acquire a plurality of reports detailing the usage and availability of a packet-switched network. In one example, the packet-switched network is an Internet Protocol (IP) network in which IP addresses (e.g., IPv4 and/or IPv6 addresses) are assigned to the plurality of hosts connected to the network.

In one example, the plurality of reports may include information such as how many Layer 3 IP connections are present on a given host (e.g., router), the maximum number of permitted IP connections on the given host, the amount of bandwidth available on each network interface card (NIC) of the given host, the hardware platform types of the given host and NIC card(s), any network locks present on the given host and NIC card(s), and/or other information.

As discussed above, the plurality of reports may be acquired from one or more databases (e.g., DB 128) or from other sources in the packet-switched network. The plurality of reports may be pushed continuously to the processing system or may be provided to the processing system on-demand (e.g., in response to periodic queries issued by the processing system).

In step 406, the processing system may classify, based on the plurality of reports, a plurality of hosts in the packet-switched network. In one example, the hosts are classified based on how likely the hosts are to be utilized in the packet-switched network in the future. For instance, a given host may be classified as a “target host” if the given host is expected to be busy or frequently utilized in the packet-switched network in the future (and should, therefore, be allocated greater IP assets) or classified as a “non-target host” if the given host is not expected to be busy or frequently utilized in the packet-switched network in the future (and should, therefore, be allocated fewer IP assets). The plurality of hosts may be classified in a number of ways, such as target/non-target, high/medium/low frequency of predicted future use, on a numerical scale (e.g., one to ten, with one representing a low frequency of predicted future use and ten representing a high frequency of predicted future use), or other ways. In one example, a machine learning technique may take data from the plurality of reports as input and may generate as an output a predicted class for each host of the plurality of hosts. For instance, a clustering algorithm (e.g., a K means algorithm or other clustering algorithms) may be used to cluster the plurality of hosts into a plurality of clusters, where each cluster of the plurality of clusters is associated with a different class.

In step 408, the processing system may identify, based on the classifying, a need of a second host of the plurality of hosts with respect to a pool of available IP assets. It should be noted that the use of the term “second host,” does not necessarily imply a specific number of hosts, but is merely meant to differentiate the second host discussed in connection with the method 400 from the first host discussed in connection with the method 300 (although, in some examples, the first host and the second host may be the same host). As discussed above, the pool of available assets may include IP assets that have never been allocated, as well as reclaimed IP assets that were allocated at least once and subsequently reclaimed (e.g., according to the method 300 described in connection with FIG. 3, above). IP assets in the pool of available IP assets may be available for allocation to hosts in the packet-switched network.

In one example, the need of the second host with respect to the pool of available IP assets may be directly related to the classification of the second host. For instance, if the second host is classified as a non-target host (or otherwise indicated to be unlikely to be frequently used in the packet-switched network in the future), then the processing system may determine that a relatively small block of IP addresses should be allocated to the second host. If, however, the second host is classified as a target host (or otherwise indicated to be likely to be frequently used in the packet-switched network in the future), then the processing system may determine that a relatively large block of IP addresses should be allocated to the second host. Thus, the size of the IP asset allocated to the second host may be directly proportional to the likelihood that the second host will be used in the packet-switched network in the future. In one example, a machine learning technique may take as input the data in the plurality of reports that relates to the second host and/or the classification of the second host and may generate as output a corresponding prediction of the need of the second host (e.g., the optimal size of the IP asset that should be allocated to the second host). In one example, the machine learning technique may generate a time-series forecast to predict the need of the second host at a particular point in time (e.g., x days in the future, y weeks in the future, etc.).

In step 410, the processing system may allocate, based on the identifying, an IP asset from the pool of available IP assets to the second host. As discussed above, the IP asset that is allocated to the second host may be selected based on the likelihood that the second host will be used in the packet-switched network in the future.

The method 400 may then return to step 404 and may continue as described above, continuously iterating through steps 404-410 until or if the method 400 is halted.

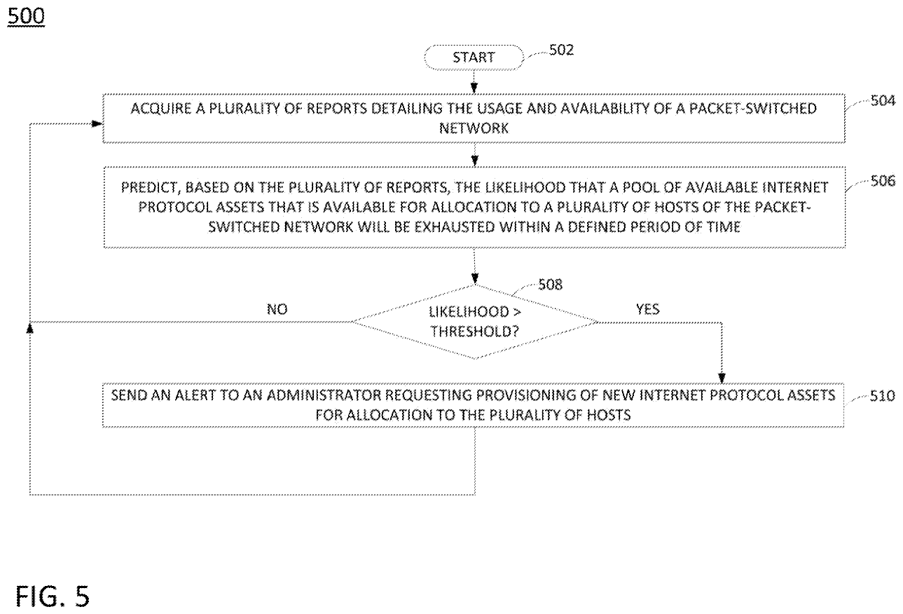

FIG. 5 illustrates a flowchart of an example method 500 for using machine learning to notify an administrator when the provisioning of new Internet Protocol assets is needed, in accordance with the present disclosure. In one example, the method 500 is performed by the provisioning server 112 of FIG. 1, by any one or more components thereof (e.g., notification logic 204, a processor performing operations stored in and loaded from a memory, etc.), or by the provisioning server 112 in conjunction with one or more other devices, such as application servers 114, servers 149, and so forth. In one example, the steps, functions, or operations of method 500 may be performed by a computing device or system 600, and/or processor 602 as described in connection with FIG. 6 below. For instance, the computing device or system 600 may represent any one or more components of a provisioning server or client device in FIG. 1 that is/are configured to perform the steps, functions and/or operations of the method 500. For illustrative purposes, the method 500 is described in greater detail below in connection with an example performed by a processing system.

The method 500 begins in step 502 and proceeds to step 504. In step 504, the processing system may acquire a plurality of reports detailing the usage and availability of a packet-switched network. In one example, the packet-switched network is an Internet Protocol (IP) network in which IP addresses (e.g., IPv4 and/or IPv6 addresses) are assigned to various hosts connected to the network.

In one example, the plurality of reports may include information such as how many Layer 3 IP connections are present on a given host (e.g., router), the maximum number of permitted IP connections on the given host, the amount of bandwidth available on each network interface card (NIC) of the given host, the hardware platform types of the given host and NIC card(s), any network locks present on the given host and NIC card(s), and/or other information.

As discussed above, the plurality of reports may be acquired from one or more databases (e.g., DB 128) or from other sources in the packet-switched network. The plurality of reports may be pushed continuously to the processing system or may be provided to the processing system on-demand (e.g., in response to periodic queries issued by the processing system).

In step 506, the processing system may predict, based on the plurality of reports, the likelihood of a pool of available IP assets that is available for allocation to hosts of the packet-switched network will be exhausted within a defined period of time (e.g., x days, y weeks, etc.). In one example, a machine learning technique may take the data in the plurality of reports as input and may generate as an output a corresponding likelihood that the pool of available IP assets will be exhausted within the defined period of time.

In step 508, the processing system may determine whether the likelihood is greater than a threshold. If the processing system concludes in step 508 that the likelihood is greater than the threshold, then the processing system may proceed to step 510. In step 510, the processing system may send an alert to an administrator (e.g., a human administrator) requesting provisioning of new IP assets for allocation to the plurality of hosts. In one example, the alert may include the likelihood that was predicted in step 506. In a further example, the alert may indicate a specific amount of IP assets that is requested for provisioning (e.g., an optimal amount, a minimum amount, a range of amounts, or the like). In one example, the processing system may use a machine learning technique that takes as input the plurality of reports and generates as an output a prediction of an amount of IP assets needed to prevent exhaustion of the pool of available IP assets for at least a defined period of time (e.g., the next x days, the next y weeks, etc.).

If, however, the processing system concludes in step 508 that the likelihood is less than the threshold, then the method 500 may return to step 504 and may continue as described above, continuously iterating through steps 504-510 until or if the method 500 is halted.

Although not expressly specified above, one or more steps of the methods 300, 400, or 500 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3, FIG. 4, or FIG. 5 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

Thus, collectively, the methods 300, 400, and 500 will minimize the number of stranded IP assets and optimize the allocation of active IP assets among the hosts of a packet-switched network. By leveraging machine learning techniques, stranded IP assets can be identified more efficiently, available IP assets can be allocated more optimally among hosts, and IP asset exhaustion can be detected before the available IP assets are actually exhausted.

The approaches disclosed herein may significantly reduce costs on the service provider/network operator side. For instance, the provisioning of a new IP asset may cost as much as twenty-five dollars per asset. However, by making it easier to identify and reclaim existing, stranded IP assets, the need to provision new IP assets may be minimized. Additionally, the value of previously underutilized IP assets may be maximized. Moreover, the customer experience may be improved by more timely identification of IP asset exhaustion events, so that service disruptions are minimized.

Furthermore, it should be noted that the approaches disclosed herein are not limited to use in reclaiming and allocating IP assets, but may also be extended (and optionally modified) to manage the optimal allocation of other finite resources as well. For instance, although the disclosed approaches may currently prove useful in managing optimal allocation of IPv4 assets, the same approaches may be used to manage IPv6 assets, assets associated with other future versions of the Internet Protocol, and non-Internet Protocol assets. In addition, the approaches disclosed herein may be deployed privately by any enterprise that wishes to optimize allocation of its IP assets, including enterprises which may be newly formed and thus may not yet have any stranded IP assets to be reclaimed. Such enterprises may still be able to optimize allocation of their IP assets based on host needs and minimize the need to request provisioning of new IP assets (and may, in the future, engage in reclaiming of stranded assets as well).

FIG. 6 depicts a high-level block diagram of a computing device specifically programmed to perform the functions described herein. For example, any one or more components or devices illustrated in FIG. 1 or FIG. 2 or described in connection with the method 300, 400, or 500 may be implemented as the system 600. As depicted in FIG. 6, the system 600 comprises a hardware processor element 602 (e.g., a microprocessor, a central processing unit (CPU) and the like), a memory 604, (e.g., random access memory (RAM), read only memory (ROM), a disk drive, an optical drive, a magnetic drive, and/or a Universal Serial Bus (USB) drive), a module 605 for reclaiming and reallocating stranded Internet Protocol assets using machine learning, and various input/output devices 606, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one embodiment, instructions and data for the present module or process 605 for reclaiming and reallocating stranded Internet Protocol assets using machine learning (e.g., a software program comprising computer-executable instructions) can be loaded into memory 604 and executed by hardware processor element 602 to implement the steps, functions or operations as discussed above in connection with the example method 300, 400, or 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for reclaiming and reallocating stranded Internet Protocol assets using machine learning (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

1. A method comprising:
acquiring, by a processing system including at least one processor, a plurality of reports detailing a usage and availability of a packet-switched network;
classifying, by the processing system based on the plurality of reports, a plurality of hosts in the packet-switched network;
identifying, by the processing system based on the classifying, a first host of the plurality of hosts from which to reclaim an internet protocol asset, wherein the internet protocol asset is underutilized by the first host; and
reclaiming, by the processing system, the internet protocol asset from the first host and reassigning the internet protocol asset to a pool of available internet protocol assets.

2. The method of claim 1, wherein the packet-switched network is an internet protocol network.

3. The method of claim 2, wherein the internet protocol asset is an internet protocol version 4 address.

4. The method of claim 2, wherein the internet protocol asset is a block of internet protocol version 4 addresses.

5. The method of claim 1, wherein the first host is a router.

6. The method of claim 1, wherein the plurality of reports specifies, for each host of the plurality of hosts: a number of layer 3 internet protocol connections present on the each host, a maximum number of permitted internet protocol connections on the each host, an amount of bandwidth available on each network interface card of the each host, a hardware platform type of the each host, a hardware platform type of the each network interface card, what network locks are present on the each host, and what network locks are present on the network interface card.

7. The method of claim 1, wherein the classifying comprises predicting how busy each host of the plurality of hosts is likely to be at a future time.

8. The method of claim 7, wherein the predicting comprises clustering the plurality of hosts into a plurality of clusters, wherein each cluster of the plurality of clusters corresponds to a different class associated with a different predicted usage frequency.

9. The method of claim 8, wherein the first host is assigned to a cluster of the plurality of clusters whose corresponding class indicates a low level of predicted usage frequency relative to other classes of a plurality of classes.

10. The method of claim 1, wherein the pool of available internet protocol assets includes internet protocol assets that have never been allocated to hosts of the plurality of hosts and reclaimed internet protocol assets that were allocated at least once to hosts of the plurality of hosts and subsequently reclaimed.

11. The method of claim 1, further comprising:
identifying, by the processing system based on the classifying, a need of a second host of the plurality of hosts with respect to the pool of available internet protocol assets; and
allocating, by the processing system based on the identifying the need of the second host, an internet protocol asset from the pool of available internet protocol assets to the second host.

12. The method of claim 11, wherein the need comprises a size of a block of internet protocol addresses.

13. The method of claim 12, wherein the size is directly proportional to a predicted frequency of future use of the second host, and wherein the predicted frequency of future use is indicated by a class to which the second host is assigned during the classifying.

14. The method of claim 13, wherein the predicted frequency of future use of the second host is predicted using a machine learning technique that uses a time-series forecast.

15. The method of claim 11, wherein the internet protocol asset that is allocated from the pool of available internet protocol assets to the second host is the internet protocol asset that is reclaimed from the first host.

16. The method of claim 1, further comprising:
predicting, by the processing system based on the plurality of reports, a likelihood that the pool of available internet protocol assets will be exhausted within a defined period of time.

17. The method of claim 16, further comprising:
sending, by the processing system in response to the likelihood being greater than a predefined threshold, an alert to an administrator requesting provisioning of new internet protocol assets for allocation to the plurality of hosts.

18. The method of claim 16, wherein the predicting the likelihood is generated using a machine learning technique.

19. A non-transitory computer-readable medium storing instructions which, when executed by a processing system including at least one processor, cause the processing system to perform operations, the operations comprising:
acquiring a plurality of reports detailing a usage and availability of a packet-switched network;
classifying, based on the plurality of reports, a plurality of hosts in the packet-switched network;
identifying, based on the classifying, a first host of the plurality of hosts from which to reclaim an internet protocol asset, wherein the internet protocol asset is underutilized by the first host; and
reclaiming the internet protocol asset from the first host and reassigning the internet protocol asset to a pool of available internet protocol assets.

20. A system comprising:
a processing system including at least one processor; and
a computer-readable medium storing instructions which, when executed by the processing system, cause the processing system to perform operations, the operations comprising:
acquiring a plurality of reports detailing a usage and availability of a packet-switched network;
classifying, based on the plurality of reports, a plurality of hosts in the packet-switched network;
identifying, based on the classifying, a first host of the plurality of hosts from which to reclaim an internet protocol asset, wherein the internet protocol asset is underutilized by the first host; and
reclaiming the internet protocol asset from the first host and reassigning the internet protocol asset to a pool of available internet protocol assets.
